(19) United States
(12) Patent Application Publication
(10) Pub. No.: US 2023/0126733 A1
(43) Pub. Date: Apr. 27, 2023

(54) SYSTEMS AND METHODS FOR IMPROVED ARCHITECTURES AND MACHINE LEARNING DRIVEN PORTALS

(71) Applicant: Cigna Intellectual Property, Inc., Wilmington, DE (US)

(72) Inventors: Edward Laslett, Annandale, VA (US); James Harding, Sydney (AU); Andrew S. Yee, Sydney (AU); Pranjivan Pillay, Sydney (AU); Garret Fontes, Visalia, CA (US); Warren Burns, Sydney (AU)

(21) Appl. No.: 17/507,946

(22) Filed: Oct. 22, 2021

(51) Int. Cl. G06Q 40/08; G06Q 30/02; G06N 20/00

(52) U.S. Cl. CPC G06Q 40/08; G06Q 30/0283; G06Q 30/0205; G06N 20/00

(57) ABSTRACT

A broker system infrastructure includes a database warehouse configured to store and provide insurance data for one or more clients, and a data analytics server in communication with the database warehouse. The broker system infrastructure analyzes policy data and member data to define a model configured to identify a relationship therebetween, receives query data including first member data, uses the policy data to generate a quote based on the query data, and applies the query data and the quote to the model to determine whether the quote is inaccurate. If the quote is inaccurate, the broker system infrastructure modifies the policy data and member data to incorporate to the quote and first member data, and analyzes at least the modified policy data and member data to modify the model such that the model is configured to identify a relationship therebetween.

### FIELD

The field generally relates to machine learning driven architectures and, more specifically, to machine learning driven architectures for use in portals for insurance brokers.

### BACKGROUND

Insurance brokers frequently face challenges in efficiently obtaining information related to quoting, selling, and managing insurance policies. The challenges are common in many jurisdictions and driven by the complexities of regulations and the volume of customers, policies, policy types, and carriers. Typically, insurance brokers access and interact with such information in online applications such as web portals. However, known web portals and other applications are unable to meet the demands of insurance brokers in a reliable fashion. Moreover, known web portals and other applications fail to scale appropriately to meet the expectations of brokers and their customers, particularly when working across borders.

### BRIEF SUMMARY

Examples described herein enable complex data sets to be organized, updated, and timely retrieved for presentation to one or more insurance brokers. In one aspect, a broker system infrastructure is provided for managing insurance data. The broker system infrastructure includes a database warehouse configured to store and provide the insurance data for one or more clients. The insurance data includes insurance client data, insurance policy data, and insurance member data. The broker system infrastructure further includes a data analytics server including a processor and a memory. The data analytics server is in communication with the database warehouse. The processor is configured to analyze at least the insurance policy data and the insurance member data to define a machine learning model configured to identify a relationship between at least the insurance policy data and the insurance member data, receive first query data including first member data, use the insurance policy data to generate an insurance quote based on the first query data, and apply the first query data and the insurance quote to the machine learning model to determine whether the insurance quote is inaccurate. On condition that the insurance quote is inaccurate, the processor is further configured to modify the insurance policy data to incorporate the insurance quote, modify the insurance member data to incorporate the first member data, and analyze at least the modified insurance policy data and the modified insurance member data to modify the machine learning model such that the machine learning model is configured to identify a relationship between at least the modified insurance policy data and the modified insurance member data.

In another aspect, a method is provided for managing insurance data. The method includes analyzing at least insurance policy data and insurance member data to define a machine learning model configured to identify a relationship between at least the insurance policy data and the insurance member data, receiving first query data including first member data, using the insurance policy data to generate an insurance quote based on the first query data, and applying the first query data and the insurance quote to the machine learning model to determine whether the insurance quote is inaccurate. On condition that the insurance quote is inaccurate, the method further includes modifying the insurance policy data to incorporate the insurance quote, modifying the insurance member data to incorporate the first member data, and analyzing at least the modified insurance policy data and the modified insurance member data to modify the machine learning model such that the machine learning model is configured to identify a relationship between at least the modified insurance policy data and the modified insurance member data.

In yet another aspect, a data analytics server is provided for use in managing insurance data. The data analytics server includes a processor and a memory. The processor is configured to analyze at least insurance policy data and insurance member data to define a machine learning model configured to identify a relationship between at least the insurance policy data and the insurance member data, receive first query data including first member data, use the insurance policy data to generate an insurance quote based on the first query data, and apply the first query data and the insurance quote to the machine learning model to determine whether the insurance quote is inaccurate. On condition that the insurance quote is inaccurate, the processor is further configured to modify the insurance policy data to incorporate the insurance quote, modify the insurance member data to incorporate the first member data, and analyze at least the modified insurance policy data and the modified insurance member data to modify the machine learning model such that the machine learning model is configured to identify a relationship between at least the modified insurance policy data and the modified insurance member data.

### BRIEF DESCRIPTION OF THE DRAWINGS

The disclosure will be better understood, and features, aspects and advantages other than those set forth above will become apparent when consideration is given to the following detailed description thereof. Such detailed description makes reference to the following drawings, wherein:

FIG. 1 is a functional block diagram of an example insurance claim processing system.

FIG. 2 is a functional block diagram of an example computing device.

FIG. 3 is a functional block diagram of a broker system infrastructure that may be deployed within the system of FIG. 1 using the computing device shown in FIG. 2.

FIG. 4 is a flow diagram representing an example method for managing insurance data from the perspective of the data analytics server shown in FIG. 3.

FIG. 5 is a flow diagram representing an example method for delivering web portal services for insurance brokers from the perspective of the data analytics server shown in FIG. 3.

FIG. 6 is a diagram of elements of one or more example computing devices that may be used in the infrastructure shown in FIG. 3.

FIG. 7 is an illustrative example of an interface presented by the server of FIG. 3 representative in part of the web portal services described herein.

In the drawings, reference numbers may be reused to identify similar and/or identical elements.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the preferred methods and materials are described below.

As described herein, an “insurance broker” is an intermediary who sells, solicits, or negotiates insurance on behalf of a client for compensation. An insurance broker is distinct from an insurance agent in that a broker typically acts on behalf of a client by negotiating with multiple insurers, while an agent represents one or more specific insurers under a contract. In many examples, the work of an insurance broker is highly regulated and subject to complex jurisdictional requirements. Further, accessing relevant information for a broker is often complex even using technical tools such as web applications or online applications.

As described above, insurance brokers frequently face challenges in efficiently obtaining information related to quoting, selling, and managing insurance policies. Due to the dynamic nature of insurance policies and the factors used to determine their cost, it is crucial that information be delivered in a timely and reliable manner. However, given the sheer volume of insurance data, known web portals and other applications fail to scale appropriately to meet the expectations of brokers and their customers, particularly when working across borders. To address these technical challenges in efficiency and scalability and the challenges facing insurance brokers generally, machine learning driven architectures are provided herein for use in portals for insurance brokers.

The described machine learning driven architectures solve technological problems related to computing systems and networks that process large, dynamic data sets. The systems and methods described herein improve computing technology by using machine learning models to efficiently identify relevant information for insurance brokers. A subset of relevant features (e.g., variables or predictors) may be determined to define one or more machine learning models. In some examples, the machine learning models may be simplified in order to make them easier to interpret, reduce training time, reduce overfitting, enhance generalization, and avoid problems in dynamic optimization. The systems and methods also utilize unique data structures and database designs to efficiently organize complex data sets and improve the architectural technology. In some examples, the data structures and/or database designs may be dynamically manipulated over time to maintain or improve accuracy, efficiency, and/or scalability. In a further aspect, the systems and methods improve computing technology by using specific algorithms to provide the broker portal tools described herein.

Generally, the systems and methods described herein are configured to perform at least the following operations: analyze insurance policy data and insurance member data to define a machine learning model configured to identify a relationship between at least the insurance policy data and the insurance member data; analyze the insurance client data to determine one or more class factors; receive first query data including first member data; receive first member data including a work location, a member citizenship, and a client citizenship; use the insurance policy data to generate an insurance quote based on the first query data; analyze the first query data to determine a class; apply the first query data and the insurance quote to the machine learning model to determine whether the insurance quote is inaccurate; determine one or more thresholds for use in determining whether the insurance quote is inaccurate; determine a likelihood of whether the insurance quote is inaccurate; compare the likelihood of whether the insurance quote is inaccurate against one or more thresholds; on condition that the insurance quote is inaccurate, modify the insurance policy data to incorporate the insurance quote, and modify the insurance member data to incorporate the first member data, and analyze at least the modified insurance policy data and the modified insurance member data to modify the machine learning model such that the machine learning model is configured to identify a relationship between at least the modified insurance policy data and the modified insurance member data; and provide a precached quote associated with the first query data to a webserver.

In some examples, a broker system infrastructure including a webserver having a webserver processor and a webserver memory is provided. The broker system infrastructure may also include a database warehouse server in communication with the webserver. The database warehouse server may have a warehouse processor and a warehouse memory and/or be configured to store and provide insurance client data, insurance policy data, insurance member data, insurance query data, and insurance quoting data.

In some examples, the broker system infrastructure includes a data analytics server having a processor and a memory. The data analytics server may be in communication with the webserver and/or the database warehouse server. The processor may be configured to receive a first portion of the insurance client data, a first portion of the insurance policy data, a first portion of the insurance member data, and a first portion of the insurance query data. The processor may also configured to define a machine learning model configured to identify predicted relationships between insurance query data, insurance client data, insurance policy data, and insurance member data. The processor may further configured to apply the received first portions of insurance query data, insurance client data, insurance policy data, and insurance member data to the machine learning model to train the machine learning model to identify predicted relationships therebetween. The processor may also configured to receive a second portion of insurance client data, a second portion of insurance policy data, a second portion of insurance member data, and a second portion of insurance query data. The processor may additionally be configured to apply the received second portions of insurance query data, insurance client data, insurance policy data, and insurance member data to the trained machine learning model to generate precached results responsive to the insurance query data. The processor may also be configured to store the generated precached results responsive to the insurance query data, wherein the generated precached results include a relationship to the responsive insurance query data. The processor may also be configured to receive a first insurance query from the webserver. The processor may also be configured to identify the precached results associated with the first insurance query and provide the precached results associated with the first insurance query to the webserver, wherein the webserver is configured to provide the precached results to a broker user.

In some examples, the processor may also be configured to receive a third portion of incomplete insurance query data lacking a complete response to at least one field of a complete insurance query. In such examples, the processor may also be configured to refine the trained machine learning model to identify relationships between the third portion of incomplete insurance query data and the precached results.

In some examples, the processor may be configured to receive the first insurance query from the webserver, wherein the first insurance query lacks a complete response to at least one field of the complete insurance query. In such examples, the processor may also be configured to identify the precached results associated with the first insurance query from the refined trained machine learning model. In such examples, the processor may be configured to provide the precached results associated with the first insurance query to the webserver, wherein the webserver is configured to provide the precached results to the broker user.

In some examples, the processor may be configured to identify a set of quoting data associated with the first portions of insurance query data, insurance client data, insurance policy data, and insurance member data. In such examples, the processor may also be configured to define a quoting machine learning model configured to identify predicted insurance quotes associated with insurance query data, insurance client data, insurance policy data, and insurance member data. In some examples, the processor may be configured to apply the identified set of quoting data and the received first portions of insurance query data, insurance client data, insurance policy data, and insurance member data to the quoting machine learning model to train the quoting machine learning model to identify predicted quotes.

In some examples, the processor may be configured to receive the second portion of insurance client data, the second portion of insurance policy data, the second portion of insurance member data, and the second portion of insurance query data. In such examples, the processor may be configured to apply the received second portions of insurance query data, insurance client data, insurance policy data, and insurance member data to the trained quoting machine learning model to generate precached quotes responsive to the insurance query data. In such examples, the processor may be configured to store the generated precached quotes responsive to the insurance query data, wherein the generated precached quotes include a relationship to the responsive insurance query data.

In some examples, the processor may be configured to receive the first insurance query from the webserver. In such examples, the processor may be configured to identify the precached quote associated with the first insurance query. In such examples, the processor may be configured to provide the precached quote associated with the first insurance query to the webserver, wherein the webserver is configured to provide the precached quote to the broker user.

In some examples, the processor may be configured to identify from the database warehouse server a client databank further including client documents including certificates of insurance, policy rules, customer guides, and renewal documents. In such examples, the processor may be configured to identify from the client documents client identifiers. In such examples, the processor may be configured to associate the precached results with the client documents based on the associated client identifiers. In such examples, the processor may be configured to provide to the webserver the precached results associated with the first insurance query and the client documents with client identifiers indicated in the precached results.

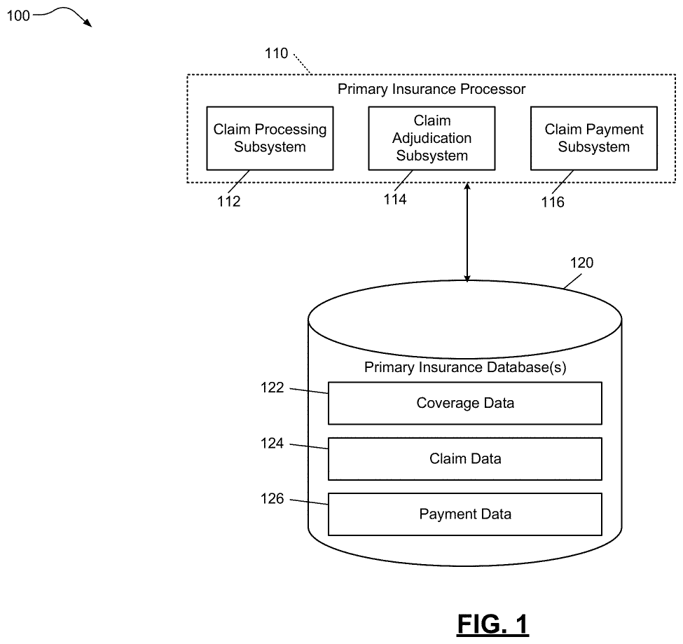

FIG. 1 is a functional block diagram of an example insurance claim processing system 100 including a primary insurance processor system 110. Primary insurance processor system 110 includes subsystems 112, 114, and 116 capable of providing claim processing, claim adjudication, and claim payment respectively. Specifically, primary insurance processor system 110 is associated with a corresponding primary insurance database system 120. As described above and herein, database systems such as database systems 120 may include one or more than one databases that each are configured to use a database management system (DBMS). In some cases DBMS systems may be distinct from one another. Further, each database is associated with a data schema that may be unique depending on whether the DBMS and clam category are distinct. As such, the databases include data that cannot be processed using common programs. Database systems 120 include necessary information stored on at least one of their underlying databases. Specifically, primary insurance database system 120 includes coverage data 122 (e.g., policy scope, policy amount, policy duration, policy territory), claim data 124 (e.g., request date, request amount), and payment data 126 (e.g., premium date, premium amount, payout date, payout amount).

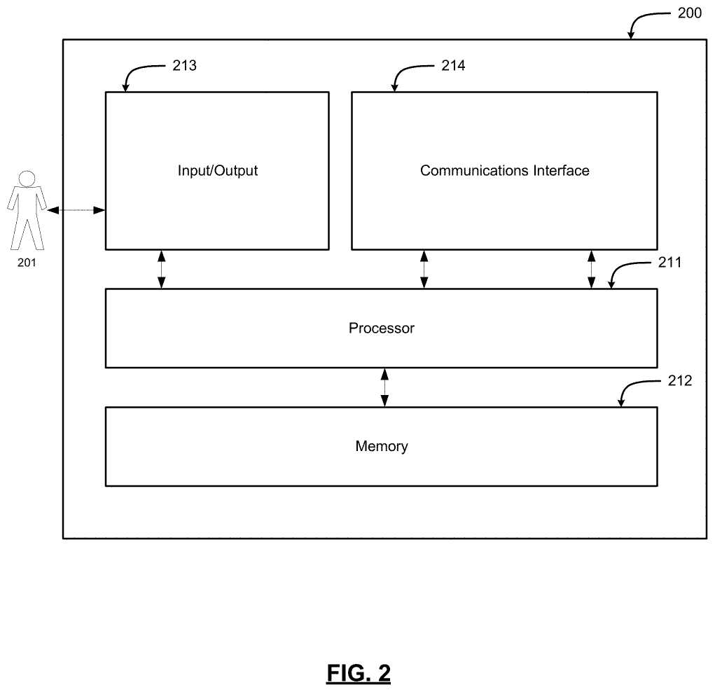

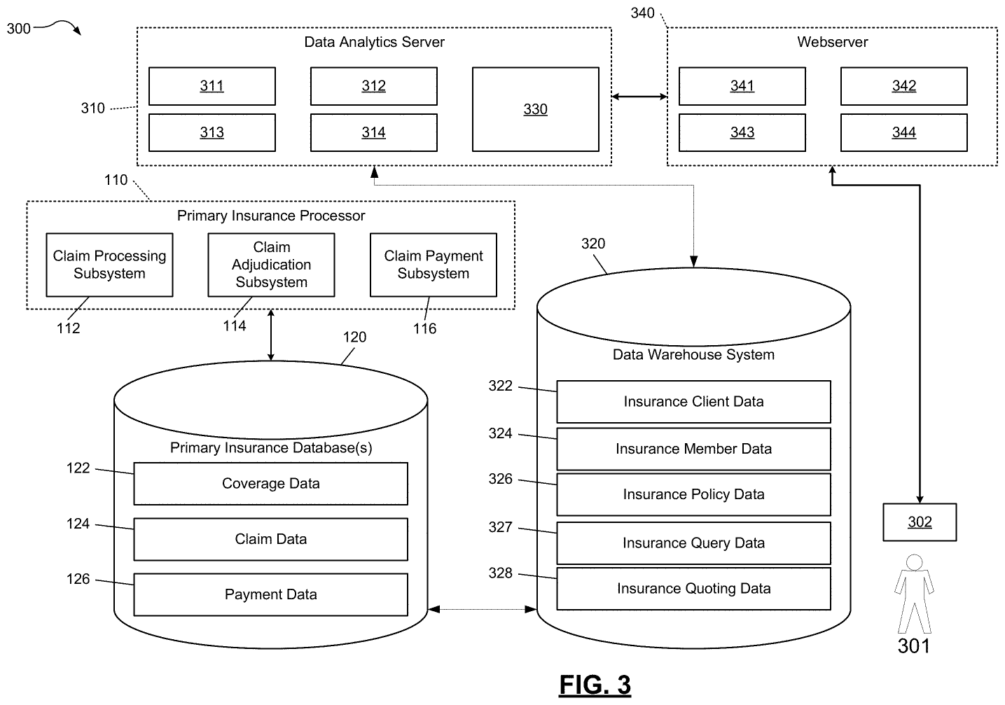

FIG. 2 is a functional block diagram of an example computing device that may be used in the method for delivering web portal services for insurance brokers described, and may represent the data analytics server, the webserver, and/or data warehouse system (all shown in FIG. 3). Specifically, computing device 200 illustrates an example configuration of a computing device for the systems shown herein, and particularly in FIGS. 1, 3, and 6. Computing device 200 illustrates an example configuration of a computing device operated by a user 201 in accordance with one embodiment of the present invention. Computing device 200 may include, but is not limited to, the data analytics server, the webserver, and/or data warehouse system (all shown in FIG. 3), other user systems, and other server systems. Computing device 200 may also include servers, desktops, laptops, mobile computing devices, stationary computing devices, computing peripheral devices, smart phones, wearable computing devices, medical computing devices, and vehicular computing devices. In some variations, computing device 200 may be any computing device capable of the described method for delivering web portal services for insurance brokers. In some variations, the characteristics of the described components may be more or less advanced, primitive, or non-functional.

In an example embodiment, computing device 200 includes a processor 211 for executing instructions. In some embodiments, executable instructions are stored in a memory area 212. Processor 211 may include one or more processing units, for example, a multi-core configuration. Memory area 212 is any device allowing information such as executable instructions and/or written works to be stored and retrieved. Memory area 212 may include one or more computer readable media.

Computing device 200 also includes at least one input/output component 213 for receiving information from and providing information to user 201. In some examples, input/output component 213 may be of limited functionality or non-functional as in the case of some wearable computing devices. In other examples, input/output component 213 is any component capable of conveying information to or receiving information from user 201. In some embodiments, input/output component 213 includes an output adapter such as a video adapter and/or an audio adapter. Input/output component 213 may alternatively include an output device such as a display device, a liquid crystal display (LCD), organic light emitting diode (OLED) display, or “electronic ink” display, or an audio output device, a speaker or headphones. Input/output component 213 may also include any devices, modules, or structures for receiving input from user 201. Input/output component 213 may therefore include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output and input device of input/output component 213. Input/output component 213 may further include multiple sub-components for carrying out input and output functions.

Computing device 200 may also include a communications interface 214, which may be communicatively coupleable to a remote device such as a remote computing device, a remote server, or any other suitable system. Communication interface 214 may include, for example, a wired or wireless network adapter or a wireless data transceiver for use with a mobile phone network, Global System for Mobile communications (GSM), 3G, 4G, 5G, or other mobile data network or Worldwide Interoperability for Microwave Access (WIMAX). Communications interface 214 is configured to allow computing device 200 to interface with any other computing device or network using an appropriate wireless or wired communications protocol such as, without limitation, BLUETOOTH®, Ethernet, or IEEE 802.11. Communications interface 214 allows computing device 200 to communicate with any other computing devices with which it is in communication or connection.

FIG. 3 is a functional block diagram of a broker system infrastructure 300 that may be deployed within the system 100 (shown in FIG. 1) using one or more computing devices 200 (shown in FIG. 2.). In one example, broker system infrastructure 300 includes primary insurance processor system 110 (along with associated subsystems 112, 114, 116) and primary insurance database system(s) 120 (along with associated data 122, 124, and 126). Broker system infrastructure 300 includes data analytics server 310 which further includes processor 311 (e.g., processor 211), memory 312 (e.g., memory 212), input/output component 313 (e.g., input/output component 213), and communications interface 314 (e.g., communications interface 214). Broker system infrastructure 300 also includes data warehouse system 320 which further includes, provides, and/or has access to insurance data, including insurance client data 322 (e.g., data associated with a company providing health insurance to its employees), insurance policy data 324 (e.g., data associated with insurance coverage, riders, etc.), insurance member data 326 (e.g., data associated with an insured), insurance query data 327, and insurance quoting data 328.

The data analytics server 310 may communicate with the data warehouse system 320 to analyze insurance data and define one or more machine learning models 330 that recognize one or more relationships between the insurance client data 322, insurance policy data 324, insurance member data 326, insurance query data 327, and/or insurance quoting data 328 and utilize such relationships to make one or more determinations. The actual cost of each policy can vary and is generally unknown until after the end of the policy period. An anticipated cost of provision of service may be determined based on a number of anticipated insurance claims and a cost estimate for each anticipated insurance claim, for example. Models 330 may be generated and/or modified to determine whether an insurance quote accurately or inaccurately covers or accounts for an anticipated cost of provision of service.

Factors that are likely to indicate or influence an anticipated cost of provision of service may be exceedingly complex. In some examples, the data analytics server 310 is configured to analyze at least some insurance data (e.g., insurance client data 322, insurance policy data 324, insurance member data 326, insurance query data 327, insurance quoting data 328) to determine one or more class factors (e.g., variables or predictors) for use in defining one or more classes. Class factors may be determined to include those factors that facilitate grouping one or more members into one or more classes of like members. Class factors may be determined, for example, by quantifying associations between various data and identifying such data having a strong correlation with an anticipated cost of provision of service. Example class factors may include, without limitation, age, gender, marital status, work location, member citizenship, client citizenship, department, job title, salary or income, and/or industry.

The correlation between a given factor and an anticipated cost of provision of service may vary based on time and/or location (e.g., jurisdiction). In some examples, the data analytics server 310 is configured to create and/or refine one or more models 330 by applying a cyclical or iterative process of defining a class, collecting or extracting historical data for the class as well as the historical cost of provision of service, determining patterns or relationships between the historical data and the historical cost of provision of service, and selecting one or more class factors that have a strong correlation with the historical cost of provision of service. Such class factors are selected based on their propensity to indicate or influence an anticipated cost of provision of service. For example, the data analytics server 310 may conduct a multivariate analysis and select one or more class factors based on a correlation coefficient between such class factors and the historical cost of provision of service.

In some examples, the data analytics server 310 may quantify one or more factors to determine a probability score or computation that describes or indicates a likelihood of whether such factors will have a strong correlation with an anticipated cost of provision of service. Probability scoring or computation may be valuable when the determination is not obtainable in a binary fashion. One or more thresholds, pertaining to how much a factor is likely to indicate or influence an anticipated cost of provision of service, may be used to determine whether to select or not select one or more class factors, and comparisons between the probability scores and the thresholds may include statistical analyses (e.g., standard deviations) and/or utilize rounding or other suitable approximations. One or more machine learning algorithms may be used to select one or more class factors, as well as to select one or more machine learning algorithms for selecting the class factors.

Broker system infrastructure 300 includes a webserver 340 which further includes processor 341 (e.g., processor 211), memory 342 (e.g., memory 212), input/output component 343 (e.g., input/output component 213), and communications interface 344 (e.g., communications interface 214). The webserver 340 is in communication with the data analytics server 310 and/or the data warehouse system 320.

In the example embodiment, a broker 301 (e.g., user 201) accesses broker system infrastructure 300 directly or indirectly using broker computing device 302 which facilitates the communication described herein and particularly via webserver 340 which presents content to broker computing device 302. In some examples, webserver 340 may be substituted with an application server that presents the same or similar content via an online application or another application.

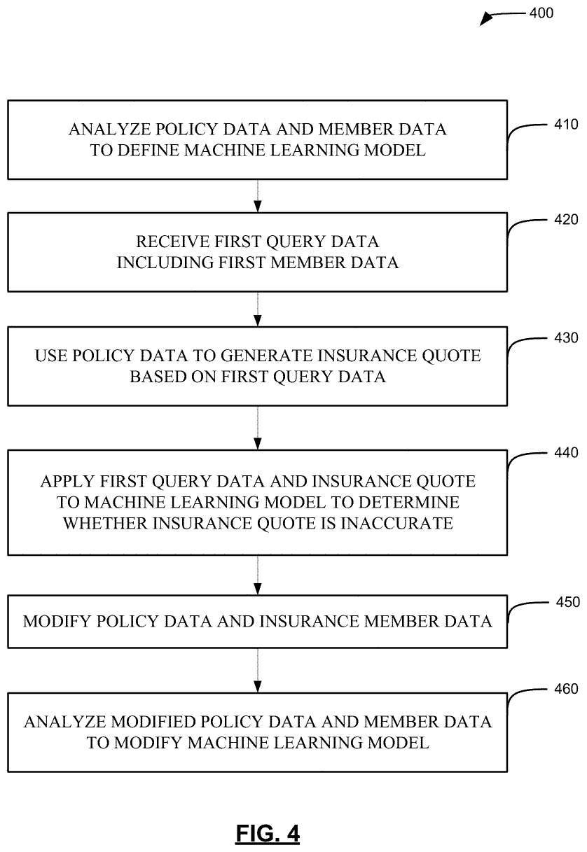

FIG. 4 is a flow diagram 400 representing an example method for managing insurance data (e.g., coverage data 122, claim data 124, payment data 126, insurance client data 322, insurance policy data 324, insurance member data 326, insurance query data 327, insurance quoting data 328) from the perspective of the data analytics server 310 (shown in FIG. 3). Data analytics server 310 is configured to analyze 410 at least insurance policy data 324 and insurance member data 326 to define one or more machine learning models 330 configured to identify a relationship between at least the insurance policy data 324 and the insurance member data 326. In some examples, the data analytics server 310 may analyze other data, including news data, weather data, and/or travel data, to account for other factors that may influence an anticipated cost of provision of service.

A first query data is received 420. The first query data may be received, for example, from the webserver 340. The first query data includes first member data associated with a member (or prospective member) associated with the first query data. First member data may include a name, a date of birth, a gender, a marital status, a work location, a citizenship, and/or an employer nationality (e.g., client citizenship). In some examples, the data analytics server 310 may facilitate automation of new data collection. For example, the quantity and/or type of first member data received or solicited by the webserver 340 and/or data analytics server 310 may depend based on the class factors. In some examples, the data analytics server 310 may analyze the first query data (e.g., first member data) to determine a class of the member. For example, the class may be determined based on one or more class factors, such as age, gender, marital status, work location, member citizenship, client citizenship, department, job title, salary or income, and/or industry.

Insurance policy data 324 is used 430 to generate an insurance quote based on the first query data including the first member data. The insurance quote may be generated, for example, based on the class and/or one or more class factors. The insurance quote may include a premium for an insurance policy. The premium may be determined at least in part on historical data associated with other policies for other members in the class. For example, the insurance quote may be generated for an expatriate, and the premium may be determined based on a first country (e.g., work location), a second country (e.g., member citizenship), and/or a third country (e.g., employer nationality). In some examples, a precached quote associated with the first query data may be transmitted to the webserver 340.

The first query data and the insurance quote are applied 440 to a machine learning model 330 to determine whether the insurance quote is accurate or inaccurate. In some examples, the machine learning model 330 may be used to compare the premium to one or more thresholds for determining an accuracy of the insurance quote. The thresholds enable the data analytics server 310 to determine or identify one or more edge cases. For example, the insurance quote may be determined to be accurate if the premium satisfies one or more consistency thresholds (e.g., if the premium is less than that of an upper edge case in the class, or other suitable amount, and/or greater than that of a lower edge case in the class, or other suitable amount). Additionally or alternatively, the insurance quote may be determined to be accurate if the premium satisfies one or more cost thresholds (e.g., if the premium is greater than an anticipated cost of provision of service for a member in the class, or other suitable amount). On the other hand, the insurance quote may be determined to be inaccurate if the premium does not satisfy one or more thresholds (e.g., if the premium is greater than that of an upper edge case in the class, less than that of a lower edge case in the class, and/or less than an anticipated cost of provision of service for a member in the class). In some examples, the data analytics server 310 may generate or transmit an alert to request additional input (e.g., from a systems analyst) regarding the accuracy of the insurance quote when the premium is greater than a first alert threshold or less than a second alert threshold. The first alert threshold may be greater than or equal to the upper consistency threshold, and/or the second alert threshold may be less than or equal to the lower consistency threshold.

In some examples, the data analytics server 310 may quantify the first query data and/or insurance quote to determine a probability score or computation that describes or indicates a likelihood of whether the insurance quote is accurate or inaccurate. The likelihood may be compared against one or more thresholds to determine whether the insurance quote is accurate or inaccurate. For example, the insurance quote may be determined to be accurate when the likelihood of whether the insurance quote is accurate satisfies a relevant threshold and/or when the likelihood of whether the insurance quote is inaccurate does not satisfy a relevant threshold. Additionally or alternatively, the insurance quote may be determined to be inaccurate when the likelihood of whether the insurance quote is accurate does not satisfy a relevant threshold and/or when the likelihood of whether the insurance quote is inaccurate satisfies a relevant threshold.

On condition that the insurance quote is inaccurate, the insurance policy data 324 and insurance member data 326 may be updated or modified 450 incorporate the insurance quote and first member data, respectively. The insurance query data 327 and/or insurance quoting data 328 may also be updated or modified 460 to incorporate the first query data and the insurance quote, respectively. The modified insurance policy data 324, modified insurance member data 326, modified insurance query data 327, and/or modified insurance quoting data 328 may then be analyzed to update or modify the machine learning model 330 such that the machine learning model 330 is configured to identify a relationship between at least the modified insurance policy data 324 and the modified insurance member data 326. This enables the machine learning model 330 to be trained based on one or more new edge cases.

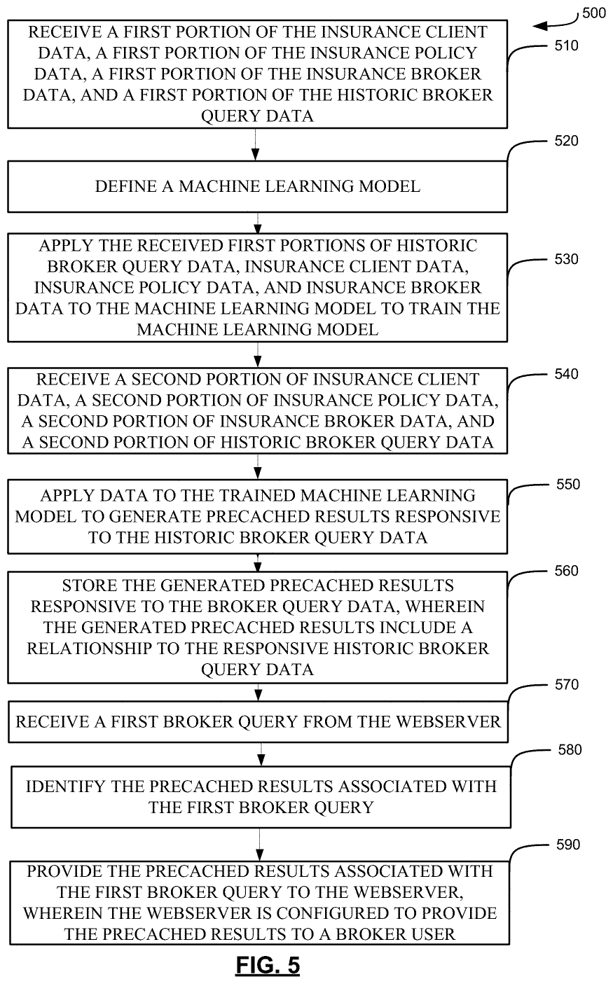

FIG. 5 is a flow diagram 500 representing an example method for delivering web portal services for insurance brokers from the perspective of the data analytics server 310 (shown in FIG. 3). Data analytics server 310 is configured to receive 510 a first portion of the insurance client data, a first portion of the insurance policy data, a first portion of the insurance member data, and a first portion of the insurance query data. Data analytics server 310 is configured to define 520 a machine learning model configured to identify predicted relationships between insurance query data, insurance client data, insurance policy data, and insurance member data. Data analytics server 310 is configured to apply 530 the received first portions of insurance query data, insurance client data, insurance policy data, and insurance member data to the machine learning model to train the machine learning model to identify predicted relationships therebetween. Data analytics server 310 is configured to receive 540 a second portion of insurance client data, a second portion of insurance policy data, a second portion of insurance member data, and a second portion of insurance query data. Data analytics server 310 is configured to apply 550 the received second portions of insurance query data, insurance client data, insurance policy data, and insurance member data to the trained machine learning model to generate precached results responsive to the insurance query data. Data analytics server 310 is configured to store 560 the generated precached results responsive to the insurance query data, wherein the generated precached results include a relationship to the responsive insurance query data. Data analytics server 310 is configured to receive 570 a first insurance query from the webserver. Data analytics server 310 is configured to identify 580 the precached results associated with the first insurance query. Data analytics server 310 is configured to provide 590 the precached results associated with the first insurance query to the webserver, wherein the webserver is configured to provide the precached results to a broker user.

In some examples, a plurality of users of a plurality of user types (e.g., broker, client, insurer) may access and/or use the same data. Each user type may have access and functional requirements that differ from the other user types for that same data and, thus, require a customized view of the data that they will be interacting with for each client policy. In some examples, the data analytics server 310 enables the webserver 340 to present a single data object that may be read, updated, and/or deleted by all users. This enables immediate consistently of experience to be provided across multiple views. For example, a multi-dimensional data object such as a data cube may be referenced from multiple perspectives at once. This object orientation of each policy uses a complex database schema that was modelled to function well for all user types while still providing a single view of the same data.

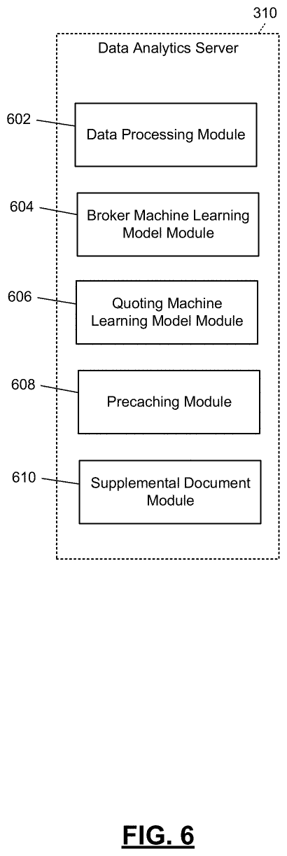

FIG. 6 is a diagram of elements 602, 604, 606, 608, and 610 of one or more example computing devices that may be used in the system 300 (shown in FIG. 3). For example, data analytics server 310 may include data processing module 602, broker machine learning model module 604, and quoting machine learning model module 606, precaching module 608, and supplemental document module 610. Such modules may be used to perform the functions described and, more specifically, to allow the broker portal to present relevant information to brokers in an efficient and scalable manner.

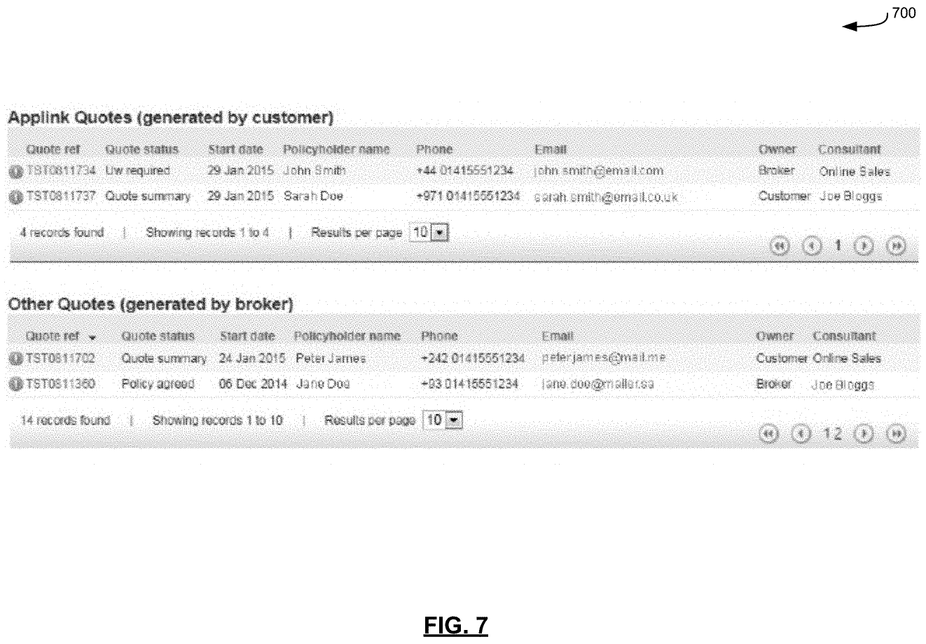

FIG. 7 is an illustrative example of an interface 700 presented by the webserver of FIG. 3 representative in part of the web portal services described herein. Interface 700 is presented by utilizing the machine learning models described herein to provide relevant data, including quoting information and supplemental documents, to brokers, members, insurers, and/or asset managers. Automated means reduce the time required to access and update complex data sets, analyze multiple insurance policies, and present multiple coverage scenarios and recommendations.

In some examples, the interface 700 provides a dashboard including an overview of a broker account. The overview may include, for example, a gross written premium, a change in gross written premium, a trend of total annual premiums, insurance renewal statuses of one or more clients, outstanding insurance balances of one or more clients, a number of clients' employees, and a number of lives insured. The interface 700 may be used to drill down and/or drill up on data. For example, the interface 700 may be used to access information associated with a particular client, including a client name, a number of the client's employees, a number of insured, a premium renewal date, a billed premium, and/or an outstanding balance. For another example, the interface 700 may be used to determine a gross written premium for all expatriates and a summary of their claims histories. For yet another example, the interface 700 may be used to access information associated with a premium calculation for a particular member.

In some examples, premiums may be calculated based on a class of a member and a tier. That is, each policy and/or rider may have a range of premiums depending on class and/or tier. As described above, members may be assigned to a class of like members. Each class may be associated with one or more policies and/or riders available to its members. For example, an expatriate may have the option to enroll in medical insurance, vision insurance, dental insurance, evacuation insurance, international employee assistance program, travel insurance, and long-term disability insurance. Tiers may relate to the number and type of dependents a member has. For example, a first tier may be for an employee (i.e., the member) only, a second tier may be for an employee and a spouse, a third tier may be for an employee and their children, and/or a fourth tier may be for an employee and their family (e.g., spouse and children).

In some examples, the data analytics server 310 may track or monitor data in the broker system infrastructure 300 over time to recognize or determine one or more changes (e.g., in number of members, age of members, family status of members, etc.) and adjust one or more premiums in accordance with the changes. For example, as new data (e.g., first query data, insurance quote) is input into and/or provided by the broker system infrastructure 300 (e.g., via interface 700), the data analytics server 310 may perform one or more checks to determine whether the new data is accurate. The first query data may include insurance member data (e.g., name, date of birth, gender, marital status, department, job title, industry, work location, current residence, citizenship, employer nationality, medical history, insurance history), and/or the insurance quote may include insurance policy data (e.g., geographic area of coverage, coverage level, payment frequency, premium). In some examples, the data analytics server 310 may use historical data to assign a member to a class, and determine a premium. Accuracy of the premium may be determined by comparing the premium to one or more a heat map including one or more thresholds. If the premium is outside an acceptable band of the heat map (e.g., premium is too high or too low), then the data analytics server 310 may use the new data to train the machine learning model 330 and update the heat map or generate a new heat map. In this manner, new edge cases may be discovered, and the acceptable band of the heat map may grow, shrink, or shift over time.

Example systems and methods for managing insurance data for one or more insurance brokers are described herein and illustrated in the accompanying drawings. This written description uses examples to disclose aspects of the disclosure and also to enable a person skilled in the art to practice the aspects, including making or using the above-described systems and executing or performing the above-described methods. Examples described herein ensure predictive accuracy and facilitate providing improved workflows, runtime performance, and data quality. By using the dynamic and extensible tools described herein, new enrollments may be accurately matched to a class and premiums may be accurately calculated, even in exceptional cases.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

When introducing elements of the disclosure or the examples thereof, the articles “a,” “an,” “the,” and “said” are intended to mean that there are one or more of the elements. References to an “embodiment” or an “example” of the present disclosure are not intended to be interpreted as excluding the existence of additional embodiments or examples that also incorporate the recited features. As used herein, the phrase at least one of A, B, and C should be construed to mean a logical (A OR B OR C), using a non-exclusive logical OR, and should not be construed to mean “at least one of A, at least one of B, and at least one of C.”

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave). The term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A broker system infrastructure for managing insurance data, comprising:
a database warehouse that stores and provides the insurance data for one or more clients, the insurance data including insurance client data, insurance policy data, and insurance member data;
a data analytics server comprising a processor and a memory, wherein the data analytics server is in communication with the database warehouse, wherein the processor is configured to:
analyze at least the insurance policy data and the insurance member data to define a machine learning model that identifies a relationship between at least the insurance policy data and the insurance member data;
receive first query data including first member data;
analyze the first query data to determine a class of a member associated with the first member data;
use the insurance policy data to generate an insurance quote for the member based on the class;
apply the class and the insurance quote to the machine learning model to determine whether the insurance quote is inaccurate based on the relationship between at least the insurance policy data and the insurance member data; and
on condition that the insurance quote is inaccurate:
modify the insurance policy data to incorporate the insurance quote;
modify the insurance member data to incorporate the first member data; and
analyze at least the modified insurance policy data and the modified insurance member data to modify the machine learning model such that the machine learning model identifies a relationship between at least the modified insurance policy data and the modified insurance member data.

2. The broker system infrastructure of claim 1, wherein the processor is further configured to:
analyze the insurance data to determine a plurality of class factors, the first query data and the insurance quote associated with one or more first class factors of the plurality of class factors;
determine a correlation between each of the plurality of class factors and an anticipated cost of provision of service; and
select one or more second class factors based on the correlation between each of the plurality of class factors and the anticipated cost of provision of service.

3. (canceled)

4. The broker system infrastructure of claim 1, wherein the processor is further configured to receive the first member data including a work location, a member citizenship, and a client citizenship, the insurance quote generated based on the work location, the member citizenship, and the client citizenship.

5. The broker system infrastructure of claim 1, wherein the processor is further configured to determine one or more thresholds for use in determining whether the insurance quote is inaccurate.

6. The broker system infrastructure of claim 1, wherein the processor is further configured to:
determine a likelihood of whether the insurance quote inaccurately accounts for an anticipated cost of provision of service; and
compare the likelihood of whether the insurance quote inaccurately accounts for the anticipated cost of provision of service against one or more thresholds.

7. The broker system infrastructure of claim 1, further comprising a webserver in communication with the database warehouse and the data analytics server, wherein the processor is further configured to provide a precached quote associated with the first query data to the web server.

8. A method for managing insurance data, said method comprising:
analyzing at least insurance policy data and insurance member data to define a machine learning model that identifies a relationship between at least the insurance policy data and the insurance member data;
receiving first query data including first member data;
analyzing the first query data to determine a class of a member associated with the first member data;
using the insurance policy data to generate an insurance quote for the member based on the class;
applying the class and the insurance quote to the machine learning model to determine whether the insurance quote is inaccurate based on the relationship between at least the insurance policy data and the insurance member data; and
on condition that the insurance quote is inaccurate:
modifying the insurance policy data to incorporate the insurance quote;
modifying the insurance member data to incorporate the first member data; and
analyzing at least the modified insurance policy data and the modified insurance member data to modify the machine learning model such that the machine learning model identifies a relationship between at least the modified insurance policy data and the modified insurance member data.

9. The method of claim 8, wherein analyzing at least the insurance policy data and the insurance member data comprises:
determining a plurality of class factors, the first query data and the insurance quote associated with one or more first class factors of the plurality of class factors;
determining a correlation between each of the plurality of class factors and an anticipated cost of provision of service; and
selecting one or more second class factors based on the correlation between each of the plurality of class factors and the anticipated cost of provision of service.

10. (canceled)

11. The method of claim 8, wherein receiving the first query data comprises receiving a work location, a member citizenship, and a client citizenship, the insurance quote generated based on the work location, the member citizenship, and the client citizenship.

12. The method of claim 8, further comprising determining one or more thresholds for use in determining whether the insurance quote is inaccurate.

13. The method of claim 8, further comprising:
determining a likelihood of whether the insurance quote inaccurately accounts for an anticipated cost of provision of service; and
comparing the likelihood of whether the insurance quote inaccurately accounts for the anticipated cost of provision of service against one or more thresholds.

14. The method of claim 8, further comprising providing a precached quote associated with the first query data to a webserver.

15. A data analytics server for use in managing insurance data, the data analytics server comprising a processor and a memory, said processor configured to:
analyze at least insurance policy data and insurance member data to define a machine learning model that identifies a relationship between at least the insurance policy data and the insurance member data;
receive first query data including first member data;
analyze the first query data to determine a class of a member associated with the first member data;
use the insurance policy data to generate an insurance quote for the member based on the class;
apply the class and the insurance quote to the machine learning model to determine whether the insurance quote is inaccurate based on the relationship between at least the insurance policy data and the insurance member data; and
on condition that the insurance quote is inaccurate:
modify the insurance policy data to incorporate the insurance quote;
modify the insurance member data to incorporate the first member data; and
analyze at least the modified insurance policy data and the modified insurance member data to modify the machine learning model such that the machine learning model identifies a relationship between at least the modified insurance policy data and the modified insurance member data.

16. The data analytics server of claim 15, wherein said processor is further configured to:
determine a plurality of class factors, the first query data and the insurance quote associated with one or more first class factors of the plurality of class factors;
determine a correlation between each of the plurality of class factors and an anticipated cost of provision of service; and
select one or more second class factors based on the correlation between each of the plurality of class factors and the anticipated cost of provision of service.

17. (canceled)

18. The data analytics server of claim 15, wherein said processor is further configured to determine one or more thresholds for use in determining whether the insurance quote is inaccurate.

19. The data analytics server of claim 15, wherein said processor is further configured to:
determine a likelihood of whether the insurance quote inaccurately accounts for an anticipated cost of provision of service; and
compare the likelihood of whether the insurance quote inaccurately accounts for the anticipated cost of provision of service against one or more thresholds.

20. The data analytics server of claim 15, wherein said processor is further configured to provide a precached quote associated with the first query data to a webserver.
